(19) United States
(12) Patent Application Publication
(10) Pub. No.: US 2016/0259388 A1
(43) Pub. Date: Sep. 8, 2016

(54) MONITORING AND CONTROL SYSTEM

(71) Applicant: AZBIL CORPORATION, Chiyoda-ku (JP)

(72) Inventors: Makoto TAKAHASHI, Chiyoda-ku (JP); Atsushi SEITA, Chiyoda-ku (JP)

(73) Assignee: AZBIL CORPORATION, Chiyoda-ku (JP)

(21) Appl. No.: 15/061,413

(22) Filed: Mar. 4, 2016

(30) Foreign Application Priority Data
Mar. 6, 2015 (JP) 2015-044908

(51) Int. Cl. G06F 1/28; H04B 17/00; H04L 12/10

(52) U.S. Cl. CPC G06F 1/28; H04L 12/10; H04B 17/00

(57) ABSTRACT

A control module includes a first power-supply-signal connection portion for connection of a power supply signal with one adjacent control module and a second power-supply-signal connection portion for connection of the power supply signal with the other adjacent control module. In the same control module, the first power-supply-signal connection portion, the second power-supply-signal connection portion, and a power input portion in a monitoring-and-control processing unit are connected to each other.

### CROSS-REFERENCE TO RELATED APPLICATIONS

This application claims priority to Japanese Application No. 2015-044908, filed Mar. 6, 2015, the entire contents of which are incorporated herein by reference.

### BACKGROUND OF THE INVENTION

1. Field of the Invention

The present invention relates to a monitoring and control system that controls multiple control targets. The monitoring and control system includes control modules that are connected to a network and that are used for each control target.

2. Description of the Related Art

Monitoring and control systems connected via networks are used in monitoring and control of facilities provided in structures, such as buildings, and plant facilities. Such a system uses control modules, such as controllers, that execute application software to provide various functions including an information collection function and a control function (refer to Japanese Unexamined Patent Application Publication No. 2000-148214). In control of control targets using the control modules, the multiple control modules are connected to each other via a data communication channel and a variety of information is exchanged between the control modules to perform the monitoring and control of an individual facility (control target) with each control module.

Use of Ethernet (IEEE802.3u: 100BASE-T) (registered trademark) as a communication method is increasingly common in such monitoring and control systems using networks for higher-speed data communication between the control modules. In network systems for the monitoring and control, a ring Ethernet network is used in which two ports are provided in each control module and the control modules are connected in a ring-shaped pattern via a communication cable, such an unshielded twisted pair (UTP) cable (refer to Japanese Unexamined Patent Application Publication No. 2005-109846).

FIG. 3 illustrates an exemplary configuration of a control apparatus in which control modules are connected to each other in the ring Ethernet network described above. FIG. 4 illustrates an example of how the multiple control modules are connected in the ring Ethernet network in related art. In the examples in FIG. 3 and FIG. 4, six control modules N1 to N6, which are arranged and mounted on a rack, such a DIN rail, are connected in a ring-shaped pattern via a communication cable LU. For example, blocking is performed at the port at the control module N3 side of the control module N4.

Due to this blocking, a tree topology is built from the original ring having a ring topology. The tree topology has two branch paths: from the root control module N1 to the control module N3 through the control module N2 and from the control module N6 to the control module N4. With the above configuration, an occurrence of a data loop is avoided even in a network physically building the ring topology.

However, since the control modules are connected to each other via the data communication channel formed of a communication cable in the module configuration described above, there are problems in that the hardware required for the connection between the control modules is made complicated to increase the product cost of the entire network and to increase the burden of maintenance.

In contrast, a technology has been developed, in which adjacent modules are connected by connecting connectors in the respective modules, each of the control modules at both ends, among the control modules, includes an adopter, and the adapters in the control modules at the ends are connected via a communication cable, between different control module groups, to connect the control modules via the data communication channel in a state optimized for the arrangement state of control targets (refer to Japanese Patent No. 5409275).

In addition, a technology to supply power to control modules using Power over Ethernet (PoE) that supplies the power through a communication cable has also been developed in connection of the control modules via a network described above (refer to Japanese Unexamined Patent Application Publication No. 2005-269890). With the PoE, it is possible to supply the power also to the control modules that are arranged at portions to which it is difficult to supply the power.

In the configuration in Japanese Patent Application No. 5409275 in which the control modules in one group are connected to each other by connecting the connectors and the communication cable is connected to the adapters connected to the control modules at the ends, no communication cable is connected to the control modules. Accordingly, the power supply using the PoE has the problem in that, although the power is supplied to the control modules at the ends connected to the adopters, the power is not supplied to the other control modules. In addition, it is not possible to supply the power to other control module groups connected to one control module group via the communication cable. In this case, since the power is individually supplied to the control modules other the control modules connected to the adaptors to which the communication cable through which the power is supplied using the PoE is connected, it is very difficult to supply the power to the other control modules.

### SUMMARY OF THE INVENTION

Accordingly, it is an object of the present invention to allow power to be more easily supplied to all the control modules in a series of control module groups.

According to an embodiment of the present invention, a monitoring and control system includes a control module group composed of a plurality of control modules which are connected to each other and each of which includes a monitoring-and-control processing unit that performs a process for monitoring and control of a monitoring control target; a first adapter which is connected to the control module at one end of the control module group and to which a communication cable is connected; and a second adapter which is connected to the control module at the other end of the control module group and to which a communication cable is connected. Power is supplied through the communication cable using PoE. The first adapter includes a power separator that separates a power supply signal supplied through the communication cable. The second adapter includes a power combiner that combines the power supply signal with a control signal. Each control module includes a first control-signal connection portion for connection of the control signal with one adjacent control module, a first power-supply-signal connection portion for connection of the power supply signal, a second control-signal connection portion for connection of the control signal with the other adjacent control module, and a second power-supply-signal connection portion for connection of the power supply signal. In the same control module, the first control-signal connection portion is connected to the second control-signal connection portion. In the same control module, the first power-supply-signal connection portion is connected to the second power-supply-signal connection portion. The first adapter includes a third control-signal connection portion for connection of the control signal with the control module that is connected and a fourth power-supply-signal connection portion for connection of the power supply signal. The second adapter includes a fifth control-signal connection portion for connection of the control signal with the control module that is connected and a sixth power-supply-signal connection portion for connection of the power supply signal. Between different control module groups, the first adapter in one control module group is connected to the second adapter in an adjacent control module group via the communication cable to form a network.

In the monitoring and control system, the control module may include a power supply connection unit to which a power supply is connected. In the same control module, the power supply connection unit, the first power-supply-signal connection portion, and the second power-supply-signal connection portion may be connected to each other.

As described above, according to the present invention, it is possible to more easily supply power to all the control modules in a series of control module groups.

### BRIEF DESCRIPTION OF THE DRAWINGS

FIG. 1 illustrates an exemplary configuration of a monitoring and control system according to an embodiment of the present invention;

FIG. 2 illustrates an exemplary configuration of another monitoring and control system according to the embodiment of the present invention;

FIG. 3 illustrates an exemplary configuration of a ring Ethernet network in related art; and

FIG. 4 illustrates an example of how multiple control modules are connected in the ring Ethernet network in related art.

### DESCRIPTION OF THE PREFERRED EMBODIMENT

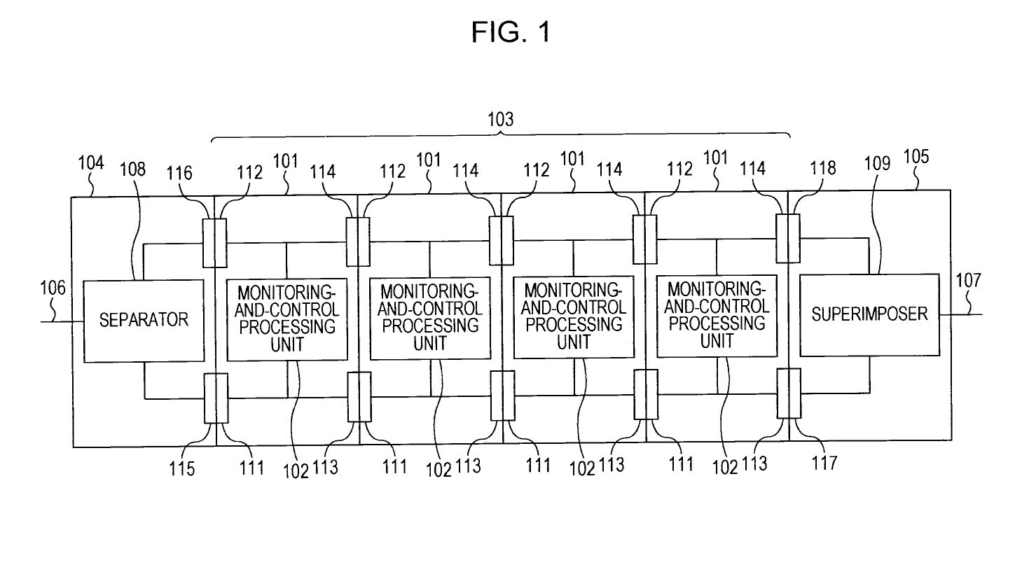

An embodiment of the present invention will herein be described with reference to the attached drawings. FIG. 1 illustrates an exemplary configuration of a monitoring and control system according to an embodiment of the present invention. Referring to FIG. 1, each control module 101 includes a monitoring-and-control processing unit 102 that performs a process for monitoring and control of monitoring control targets. Multiple control modules 101 are connected to each other to compose a control module group 103. In the example in FIG. 1, four control modules 101 are connected. The control module group 103 servers as a control apparatus, which controls the control targets that are connected via signal lines (not illustrated).

A first adapter 104 is connected to the control module 101 at one end of the control module group 103. A second adapter 105 is connected to the control module 101 at the other end of the control module group 103. A communication cable 106 is connected to the first adapter 104 and a communication cable 107 is connected to the second adapter 105. Power is capable of being supplied through he communication cables 106 and 107 using the PoE.

The first adapter 104 includes a power separator 108 that separates a power supply signal supplied through the communication cable 106. The second adapter 105 includes a power combiner 109 that combines the power supply signal with a control signal.

In addition, each control module 101 includes a first control-signal connection portion 111 for connection of the control signal with one adjacent control module 101, a first power-supply-signal connection portion 112 for connection of the power supply signal, a second control-signal connection portion 113 for connection of the control signal with the other adjacent control module 101, and a second power-supply-signal connection portion 114 for connection of the power supply signal.

In the same control module 101, the first control-signal connection portion 111, the second control-signal connection portion 113, and a control-signal input-output portion in the monitoring-and-control processing unit 102 are connected to each other. In the same control module 101, the first power-supply-signal connection portion 112, the second power-supply-signal connection portion 114, and a power input portion in the monitoring-and-control processing unit 102 are connected to each other.

The first adapter 104 includes a third control-signal connection portion 115 for connection of the control signal with the control module 101 that is connected and a fourth power-supply-signal connection portion 116 for connection of the power supply signal. The third control-signal connection portion 115 is connected to the first control-signal connection portion 111, and the fourth power-supply-signal connection portion 116 is connected to the first power-supply-signal connection portion 112.

The second adapter 105 includes a fifth control-signal connection portion 117 for connection of the control signal with the control module 101 that is connected and a sixth power-supply-signal connection portion 118 for connection of the power supply signal. The fifth control-signal connection portion 117 is connected to the second control-signal connection portion 113, and the sixth power-supply-signal connection portion 118 is connected to the second power-supply-signal connection portion 114. Between different control module groups 103, the first adapter 104 in one control module group 103 is connected to the second adapter 105 in an adjacent control module group via the communication cable 107 to form a network. The first control-signal connection portion 111 and the second control-signal connection portion 113 each include, for example, a communication line to connect a transmission-reception port of a physical layer portion of the control module 101 to an adjacent control module 101 and a communication line to connect the transmission-reception port of the physical layer portion of the control module 101 to an adjacent control module 101 via a capacitive element.

The control module 101 described above includes the first power-supply-signal connection portion 112 and the second power-supply-signal connection portion 114 and, in the same control module 101, the first power-supply-signal connection portion 112, the second power-supply-signal connection portion 114, and the power input portion in the monitoring-and-control processing unit 102 are connected to each other. As a result, upon supply of power to the first power-supply-signal connection portion 112 in the control module 101 at one end to which the first adapter 104 is connected, the power is supplied to all the control modules 101 in the control module group 103 via the first power-supply-signal connection portion 112 and the second power-supply-signal connection portion 114.

As described above, according to the embodiment, it is not necessary to provide individual power supplies for the control modules 101 other than the control module 101 to which the first adapter 104 is connected and, thus, it is possible to more easily supply the power to all the control modules 101 in the control module group 103. In addition, since a power signal is also supplied to the communication cable 107 in the second adapter 105, the power is supplied to other control module groups (not illustrated) connected to the control module group 103 via the communication cable 107.

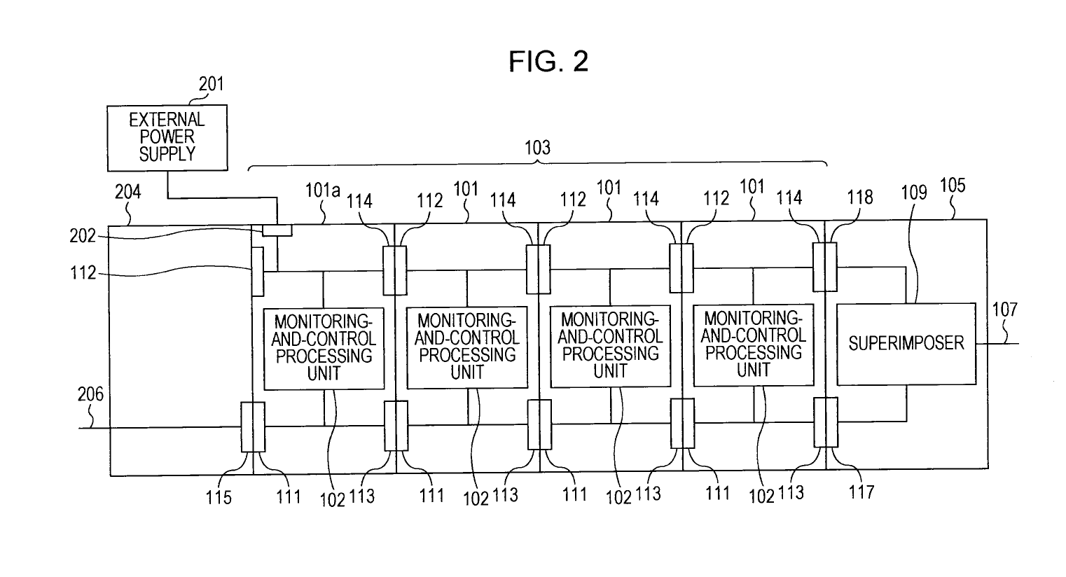

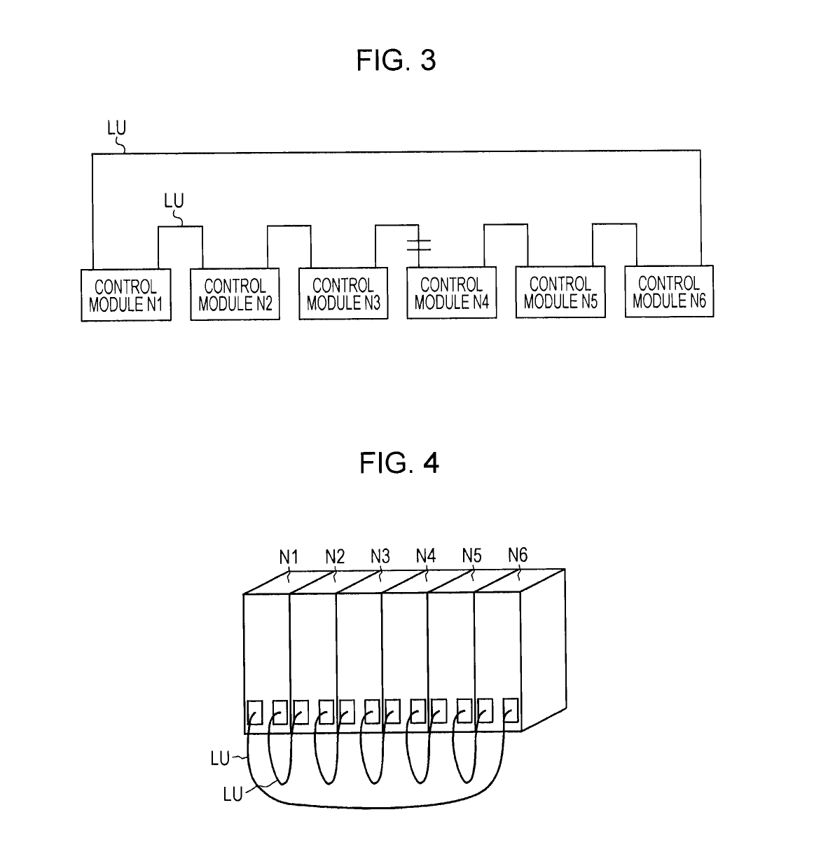

When a communication cable 206 via which power is not supplied using the PoE is connected, as illustrated in FIG. 2, an external power supply 201 is used. In this case, a control module 101a at the end to which a first adapter 204 is connected includes a power supply connection unit 202 to which the external power supply 201 is connected. The control module 101a also includes the monitoring-and-control processing unit 102, the first control-signal connection portion 111, the first power-supply-signal connection portion 112, the second control-signal connection portion 113, and the second power-supply-signal connection portion 114, as in the other control modules 101.

In the control module 101a, the first control-signal connection portion 111, the second control-signal connection portion 113, and the control-signal input-output portion in the monitoring-and-control processing unit 102 are connected to each other. In the control module 101a, the first power-supply-signal connection portion 112, the second power-supply-signal connection portion 114, the power supply connection unit 202, and the power input portion in the monitoring-and-control processing unit 102 are connected to each other. The first adapter 204 may not include the power separator.

Upon supply of power to the power supply connection unit 202 in the control module 101a at one end to which the first adapter 204 is connected, the use of the control module 101a described above allows the power to be supplied to all the control modules 101 in the control module group 103 via the first power-supply-signal connection portion 112 and he second power-supply-signal connection portion 114.

Also with the above configuration, it is not necessary to provide individual power supplies for all the control modules 101, thereby more easily supplying the power to all the control modules 101 in the control module group 103. Since the power signal is also supplied to the communication cable 107 in the second adapter 105 also in this configuration, the power is capable of being supplied to other control module groups (not illustrated) connected to the control module group 103 via the communication cable 107.

As described above, according to the embodiment of the present invention, the control module includes the first power-supply-signal connection portion for connection of the power supply signal with one adjacent control module and the second power-supply-signal connection portion for connection of the power supply signal with the other adjacent control module. Accordingly, it is possible to more easily supply the power to all the control modules in a series of control module groups.

While the invention is described in terms of some specific examples and embodiment, it will be clear that this invention is not limited to these specific examples and embodiment and that many changes and modified embodiments will be obvious to those skilled in the art without departing from the true spirit and scope of the invention.

What is claimed is:

1. A monitoring and control system comprising:
a control module group composed of a plurality of control modules which are connected to each other and each of which includes a monitoring-and-control processing unit that performs a process for monitoring and control of a monitoring control target;
a first adapter which is connected to the control module at one end of the control module group and to which a communication cable is connected; and
a second adapter which is connected to the control module at the other end of the control module group and to which a communication cable is connected,
wherein power is supplied through the communication cable using PoE,
wherein the first adapter includes a power separator that separates a power supply signal supplied through the communication cable,
wherein the second adapter includes a power combiner that combines the power supply signal with a control signal,
wherein each control module includes a first control-signal connection portion for connection of the control signal with one adjacent control module, a first power-supply-signal connection portion for connection of the power supply signal, a second control-signal connection portion for connection of the control signal with the other adjacent control module, and a second power-supply-signal connection portion for connection of the power supply signal,
wherein, in the same control module, the first control-signal connection portion is connected to the second control-signal connection portion,
wherein, in the same control module, the first power-supply-signal connection portion is connected to the second power-supply-signal connection portion,
wherein the first adapter includes a third control-signal connection portion for connection of the control signal with the control module that is connected and a fourth power-supply-signal connection portion for connection of the power supply signal,
wherein the second adapter includes a fifth control-signal connection portion for connection of the control signal with the control module that is connected and a sixth power-supply-signal connection portion for connection of the power supply signal, and
wherein, between different control module groups, the first adapter in one control module group is connected to the second adapter in an adjacent control module group via the communication cable to form a network.

2. The monitoring and control system according to claim 1,
wherein the control module includes a power supply connection unit to which a power supply is connected, and
wherein, in the same control module, the power supply connection unit, the first power-supply-signal connection portion, and the second power-supply-signal connection portion are connected to each other.
